(19) United States
(12) Patent Application Publication
(10) Pub. No.: US 2014/0329061 A1
(43) Pub. Date: Nov. 6, 2014

(54) Durable Hydrophilic Dry Adhesives with Hierarchical Structure and Method of Making

(71) Applicants: Jue Lu, Okemos, MI (US); Parviz Soroushian, Okemos, MI (US); Amirpasha Peyvandi, Lansing, MI (US)

(72) Inventors: Jue Lu, Okemos, MI (US); Parviz Soroushian, Okemos, MI (US); Amirpasha Peyvandi, Lansing, MI (US)

(73) Assignee: METNA CO, Lansing, MI (US)

(21) Appl. No.: 13/565,295

(22) Filed: Aug. 2, 2012

(51) Int. Cl. C09J 179/02; C09J 7/00; B05D 3/06

(52) U.S. Cl. CPC C09J 179/02; B05D 3/068; C09J 7/00; B05D 2256/00; B05D 2201/02; B05D 2503/00; B05D 2518/10; B05D 2502/005; B05D 2518/00; B05D 2350/00; C09J 2201/626
USPC 428/201; 427/538

(57) ABSTRACT

Provided is a method of making durable hydrophilic and hierarchical structures containing nano and micro features used as dry adhesives. The method includes introduction of hydrophilic, nanostructured features on the micro-scale tips of fibrillar arrays through UV/Ozone (UVO) and oxygen plasma treatment; the method also includes further coating of the hierarchical structure with a polyelectrolyte via electrostatically-driven self-assembly to improve the hydrophilic stability of the treated fibril tip surfaces.

### FEDERALLY SPONSORED RESEARCH OR DEVELOPMENT

The present invention was supported in part by Grant Number FA8651-07-C-0092 awarded by the U.S. Air Force. The U.S. Government may have certain rights in the invention.

### CROSS-REFERENCE TO RELATED APPLICATIONS

Not applicable.

### BACKGROUND—PRIOR ART

The following is a tabulation of some prior art that presently appears relevant:

### U.S. Patents

| Patent Number | Kind Code | Issue Date | Patentee |
|---|---|---|---|
| 7,632,417 | B2 | 2009 Dec. 15 | Suh et al. |
| 7,479,198 | B2 | 2009 Jan. 20 | Guffrey et al. |
| 7,479,318 | B2 | 2009 Jan. 20 | Jagota et al. |

### U.S. Patent Application Publications

| Publication No. | Kind Code | Publ. Date | Applicant |
|---|---|---|---|
| 2010/0136281 | A1 | 2010 Jun. 03 | Sitti et al. |
| 2009/0114618 | A1 | 2009 May 07 | Zhang et al. |
| 2009/0041986 | A1 | 2009 Feb. 12 | Zhang et al. |

### Nonpatent Literature Documents

C. de Menezes Atayde and I. Doi (2010). “Highly stable hydrophilic surfaces of PDMS thin layer obtained by UV radiation and oxygen plasma treatments.” Phys. Status Solid C 7: 189-192.

A. del Campo, C. Greiner and E. Arzt (2007). “Contact shape controls adhesion of bioinspired fibrillar surfaces.” Langmuir 23(20): 10235-10243.

A. Olah, H. Hillborg and G. J. Vancso (2005). “Hydrophobic recovery of UV/ozone treated poly(dimethylsiloxane): adhesion studies by contact mechanics and mechanism of surface modification.” Applied Surface Science 239(3-4): 410-423.

S. C. Park, S. K. Koh and K. D. Pae (1998). “Effects of surface modification by Ar+ irradiation on wettability of surfaces of poly(ethylene terephthalate) films.” Polymer Engineering & Science 38: 1185-1192.

J. B. Puthoff M. S. Prowse, M. Wilkinson and K. Autumn (2010). “Changes in materials properties explain the effects of humidity on gecko adhesion.” Journal of Experimental Biology 213(21): 3699-3704.

M. L. Sham, J. Li, P. C. Ma and J. K. Kim (2009). “Cleaning and Functionalization of Polymer Surfaces and Nanoscale Carbon Fillers by UV/Ozone Treatment: A Review.” Journal of Composite Materials 43(14): 1537-1564.

W. X. Sun, P. Neuzil, T. S. Kustandi, S. Oh and V. D. Samper (2005). “The nature of the gecko lizard adhesive force.” Biophysical Journal 89(2): L14-L17.

T. Yamamoto, J. R. Newsome and D. S. Ensor (1995). “Modification of surface energy, dry etching, and organic film removal using atmospheric-pressure pulsed-corona plasma.” IEEE Trans Ind. APPLIED PHYSICS LETTERS 31: 494-499

### FIELD OF INVENTION

The present invention relates to hydrophilic dry adhesives, and more particularly to hydrophilic polymeric microfibrillar dry adhesives with hierarchical structure containing nano- and micro-scale features, where adhesion is accomplished using both van der Waals attraction and capillary forces.

### BACKGROUND OF THE INVENTION

Used by lizards and insects (including geckos, spiders, beetles, crickets and flies) to climb vertical and even inverted surfaces, the fine hair adhesive system is an excellent example of convergent evolution in biology. This biological adhesion system consists of finely structured protruding hairs with cross-sectional dimensions ranging from nano- to micro-scale, depending on the animal species. The density of surface hairs increases with the body weight of animal, and gecko has the highest hair density and the finest (nano-scale) hairs among all animal species that have been studied. Gecko's nano-scale fibrillar structure develops high adhesion capacity with broad ranges of surface materials at high reliability levels. Self-cleaning is another appealing feature of the gecko-foot adhesion mechanism, which relies primarily on a nano-scale fibrillar structure. The nano-scale hairs (spatulae) in gecko-foot are supported by micro-scale hairs (setae). This two-scale structure is key to gecko's ability to adhere to very rough surfaces, and also to its agility involving effortless detachment of its strongly adhered feet via a peeling action.

The structure and unique capabilities of gecko-foot have intrigued biologists and engineers for many years, who have conducted several investigations into various aspects of the gecko-foot structure and behavior. Current efforts to mimic gecko foot and develop bio-inspired adhesives follow two broad lines of thought: one uses relatively soft elastomer fibers such as polydimethylsiloxane (PDMS) and polyurethane (PU), and the other uses stiff, very high aspect ratio carbon nanotubes or nanofibers. Although some investigations have concluded that the major driving force for holding gecko lizards on a surface arises from the van der Waals attractions, some debate that the capillary force is the primary mechanism of gecko-foot adhesion to different surfaces see e.g. W. X. Sun, P. Neuzil, T. S. Kustandi, S. Oh and V. D. Sarver, Biophysical Journal 2005, 89(2), L14; and J. B. Puthoff M. S. Prowse, M. Wilkinson and K. Autumn, Journal of Experimental Biology 2010, 213(21), 3699); theoretical investigations indicate that capillary force can contribute significantly to the adhesion capacity of fibrillar arrays. In addition, adhesion against rough surfaces benefits even more from the capillary effect, as the capillary water bridging two surfaces is not significantly affected by the surface roughness; the van der Waals force, on the other hand, is a short-distance force that is significantly affected by surface roughness.

Different surface modification techniques are known in the art to after hydrophobic polymeric surfaces to assume hydrophilic qualities. These modification techniques include multicomponent polyaddition reaction, corona discharges, oxygen plasma, and UV irradiation with or without ozone treatment. In recent years, UVO treatment has been extensively applied to natural and synthetic polymers towards modification of the surface chemistry and wetting characteristics. UVO treatment has been used for enhancement of interfacial adhesion in adhesive joints and composites, as in M. L. Sham, J. Li, P. C. Ma and J. K. Kim, Journal of Composite Materials 2009, 43(14), 1537. UV ozone treatment is a photosensitized oxidation process, in which the excitation and dissociation of the polymeric molecules by short-wavelength UV radiation can take place; in addition, the UV light dissociates oxygen to generate atomic oxygen which easily reacts with oxygen molecules to form ozone. The highly reactive atomic oxygen and ozone react with polymers to form proxy, hydroxyl, carbonyl etc, and thus increase the wettability of the surface polymer. Another approach to improving the water-wettability of polyurethane and PDMS surfaces involves low-pressure oxygen plasma treatment (see e.g. T. Yamamoto, J. R. Newsome and D. S. Ensor, IEEE Trans Ind. Applied Physics Letters 1995, 31, 494; and S. C. Park, S. K. Koh and K. D. Pae, Polymer Engineering & Science 1998, 38, 1185). This approach Is environmentally friendly and easy to implement. Low-pressure oxygen plasma treatment can be implemented at moderate temperatures. Plasma treatment can be performed by indirect corona treatment, or simply using an oxygen-rich butane gas flame.

The other benefit of surface UVO and plasma oxygen treatment of polymer surfaces is the production of nanostructured surfaces under proper operation conditions. Successful extension of this practice to surface treatment of polymer fibrillar arrays for producing nanostructured fibril tips, would offer a practical, low-cost, high-throughput and scalable approach to production of hierarchical structures simulating those of gecko-foot, comprising micro-fibrils culminated in nanostructured tips for achieving highly desired conformability and adhesion qualities.

An important concern with both UV ozone and oxygen plasma treatment is the lack of permanency of the effects on polymer surfaces. Hydrophobic recovery generally occurs with oxidized polymer layers, and is caused by reversible relaxation processes of polar groups; the other dominating mechanism for PDMS is the migration of free siloxanes from the bulk to the surface through a porous or cracked hydrophilic silica-like layer, as explained in A. Olah, H. Hillborg and G. J. Vancso, Applied Surface Science 2005, 239, 410. Hydrophobic recovery and the corresponding loss of the adhesion capacity of oxygen plasma-treated PDMS and polyurethane surfaces are thus important concerns. One can improve the stability of O₂ plasma treatment effects by adhering polymer molecules of desired qualities to treated surfaces, as illustrated in C. de Menezes Atayde and I. Doi, Physica Status Solidi (c) 2010, 7, 189.

It is an object of the present invention to manufacture permanently hydrophilic polymeric fibrillar arrays with hierarchical structures to enable adhesion via both van der waar force attraction and the capillary effect. Manufacturing of microfibrillar structures to mimic the gecko-foot structure is known in the art. For example, US patent application US2010/0136281 A1Declaration discloses a dry adhesive based on polymeric microfibrillar arrays and a method of forming a dry adhesive using soft molding of polymer precursors. U.S. Pat. No. 7,632,417 B2 teaches a method of forming a nanostructure having a nano-sized diameter and a high aspect ratio by the microcontact printing using an engraved part of the mold. Other patents, such as U.S. Pat. No. 7,479,198 B2, U.S. Pat. No. 7,479,318 B2 and patent application US 2009/0114618 A1 and US 2009/0041986 A1 are focused on the manufacture of a gecko-like hierarchical fibrillar microstructure. All the above cited prior arts have been focused on the geometrical design (i.e. dimensions and spacing of the pillars, shapes of the tips, mechanical properties of the materials); none of them discloses the approach taken here to alternation of the surface properties of dry adhesives to enhance adhesion.

### SUMMARY

The following embodiments and aspects thereof are described and illustrated in conjunction with products and methods which are meant to be exemplary and illustrative, not limiting in scope.

The present invention entails methods for improving wettability and altering the surface morphology of polymer microfibrillar structures for bio-inspired adhesives, including but not limited to, UVO and plasma treatment. UVO treatment is a photosensitized oxidation process, where the molecules on either the substrate surface or the organic contaminants are excited and/or dissociated by absorption of short-wavelength UV radiation. The degree of ozone treatment can be controlled by the time of exposure and the distance between the sample and UV light. Another method to treat polymeric surfaces is to use low-pressure oxygen plasma treatment. This treatment forms an oxidized surface layer of about 130-160 nm thickness. Furthermore, plasma treatment causes breakage of chemical bonds because it involves bombardment of the polymer surface with ions of high energy, thus creating dangling bonds which react with the hydroxyl groups from atmosphere when exposed to air. This explains the significant decrease of water contact angle after plasma treatment. Plasma treatment also changes the surface morphology by introducing fine features which increase surface roughness.

In one aspect, the presented invention is making polymeric microfibrillar surfaces more hydrophilic. Treatment of polymer microfibrillar structures can greatly benefit their adhesion capacities in medium to high humidity environments due to improved surface wettability.

In another aspect, the treatment methods produce nanostructured surfaces on the tip of microfibrils under proper operational conditions, which yield hierarchical structures comprising microfibrils culminating in nanostructured tips, simulating those of gecko-foot, for achieving highly desired conformability and adhesion qualities against surfaces of different types and roughness conditions. The combination of molecular dissociation and increased roughness at fibril tips can benefit the adhesion capacity of fibrillar structures. This approach offers a practical, low-cost, high-throughput and scalable process for production of hierarchical structures.

Another aspect of the invention covers durable (permanent) hydrophilic dry adhesive with microfibrillar structures. Surface modification of fibril tips involving UVO or plasma treatment tends to degrade (experiencing hydrophobic recovery) over time. Stability of hydrophilic surfaces is improved through coating with a polyelectrolyte (PE), such as poly(diallyl dimethyl ammonium chloride) (PDAC), poly(ally, amine) (PAH) and polyethyleneimine(PEI) via self-assembly. After surface treatment with UVO and oxygen plasma treatment, the surface is negatively charged with polar functional groups. A thin (nano-scale) layer of positively charged PE can thus be assembled on the treated surface by electrostatic attraction or hydrogen bonding. The self-assembly of a thin polyelectrolyte layer preserves the hydrophilic properties of the surface over time, rendering stable fibril tip characteristics which provide for durable adhesion qualities.

### BRIEF DESCRIPTION OF THE DRAWINGS

Accompanying drawings help with explaining the invented durable hydrophilic microfibrillar structures for dry adhesive applications, method of making them, and basic principles of their operations. The accompanying drawings are only for the purpose of illustrating the embodiments of the invented methods, and not for the purpose of limiting the invention. In the drawings:

FIG. 1 presents an SEM image of polyurethane fibrillar arrays with 20 μm fibril diameter and length, which is used as dry bio-inspired adhesive.

FIG. 2 schematically presents the water contact angle on a polymer microfibrillar structure before any surface treatment.

FIG. 3 schematically presents the reduced water contact angle, indicating enhanced wettability, on a polymer microfibrillar structure after surface treatment.

FIG. 4A-D schematically presents the process of surface treatment of polymer fibril tips for producing durable hydrophilic dry adhesives with hierachical structures.

FIG. 5 schematically presents the tip morphology of microfibrils after surface treatment.

FIG. 6 is an atomic force microscope (AFM) image of a fibril tip surface before any treatment.

FIG. 7 is an atomic force microscope (AFM) image of a fibril tip surface after treatment.

FIG. 8 presents a comparison of the adhesion capacities of polyurethane fibrillar arrays on glass substrates with and without UVO surface treatment.

FIG. 9 presents a comparison of the adhesion capacities of PDMS fibrillar arrays on glass substrates with and without UVO surface treatment.

FIG. 10 presents a comparison of the adhesion capacities of polyurethane fibrillar arrays on glass substrates without and with oxygen plasma surface treatment.

FIG. 11 presents water contact angle measurements over time of polyurethane microfibrillar arrays with oxygen plasma treatment and PEI coating

FIG. 12 presents measurements of adhesion capacities of polyurethane microfibrillar arrays over time after oxygen plasma treatment and PEI coating.

### DETAILED DESCRIPTION

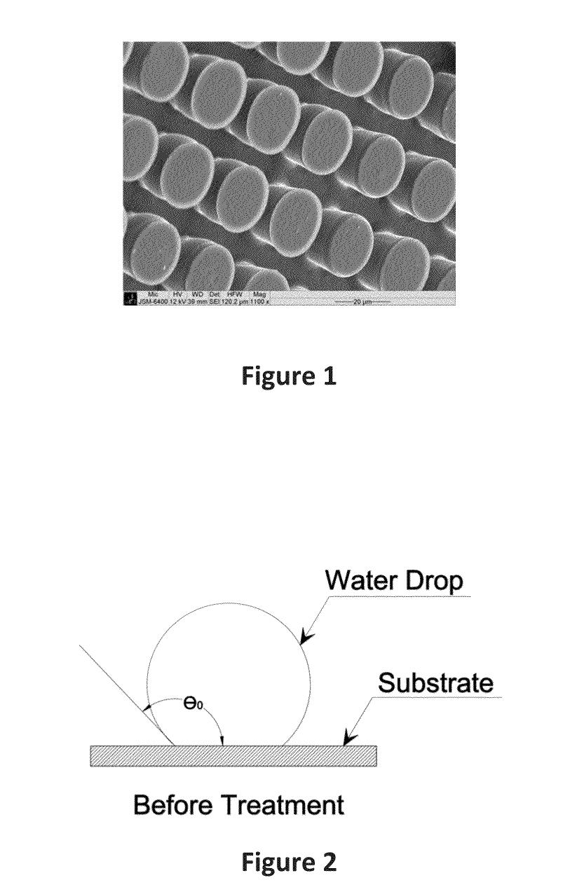

The present invention relates to surface treatment methods which enhance the adhesion capacity of synthetic dry adhesives. The term “dry adhesive”, as used herein, refers to solid adhesives based on synthetic nano- and micro-structures mimicking the gecko-foot adhesion mechanism. Dry adhesives contrast traditional liquid adhesives, including pressure sensitive adhesives which flow under pressure to conform to surface roughness. FIG. 1 shows a microscopic image of an example synthetic polymeric dry adhesive with fibrillar structures. Suitable techniques for fabricating such polymeric fibrillar structures include introduction of incisions on polymer films, hot embossing of polymer melts with microfabricated masters, direct drawing of polymer fibrils, lithographic structuring of resist films, filling of nano-porous membranes, and soft-molding of elastomeric precursors on microfabricated templates. Soft molding is preferred as a relatively simple and inexpensive process, which provides flexibility in tailoring the geometry and curvature of fibrillar structures. The polymeric materials can be any thermoplastic and thermosetting polymers, including elastomers, such as, but not limited to epoxy, poly(methyl methacrylate) (PMMA)), polypropylene (PP), polyurethane (PU) and polydimethylsiloxane (PDMS). The diameters of the fibrils are in the range from 1 micrometer to 500 micrometer, and length in the range of 1 micrometer to 1000 micrometer. One skilled in the art can design suitable combinations of diameter and length for achieving desired adhesion. FIG. 1 shows an example bio-inspired adhesive composed of polyurethane fibrils with diameter of 20 micrometer and length of 20 micrometer, produced by soft molding on microfabricated templates. The tips of fibrils are preferably enlarged to assume mushroom-like shapes which provide improved adhesion, as described by A. del Campo, C. Greiner and E. Arzt, Langmuir, 2007, 23(20), 10235. The treatment (enlargement) of fibril tips involves “inking” of the tips in a spinned film of the polymer precursor in order to attach a small drop of the precursor on fibril tips. The inked array is then pressed (“printed”) against a flat surface, and cured. This renders fibrils with a flexible and flat tip with an enlarged diameter which depends on the thickness of the spin-coated precursor film.

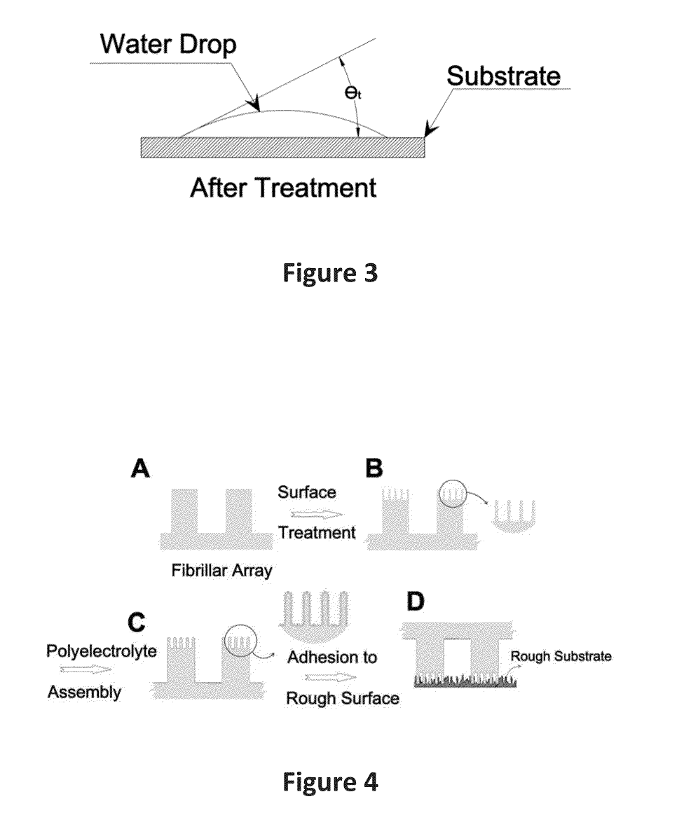

The polymers used for fabricating fibrillar structures are generally hydrophobic, and micropatterning of the polymer surfaces can further increase their hydrophobicity. Water contact angle is a parameter which reflects on the wettability inclination of the surface. FIG. 2 shows a water contact angle above 90° on polymer fibrillar structures. For example, plain PDMS and polyurethane surfaces show typical water contact angles of 105 and 76°, respectively, while their microfibrillar structures show a water contact angle of 143 and 125°, respectively. Due to the increased proportion of water/air interfaces resulting from introduction of fibrillar structure son the surface, a phenomenon commonly known as the lotus effect occurs where water contact angle is increased. Dry adhesives rely on solid contact with the substrate by van der Waals forces and, depending on the surface moisture condition, capillary forces. It is known that capillary force depends on the water contact angle of mating surfaces. Hydrophilic surfaces with smaller water contact angle (referring to FIG. 3) provide high wettability (hydrophilic) qualities, which mobilize adhesion via capillary effect between contacting surfaces.

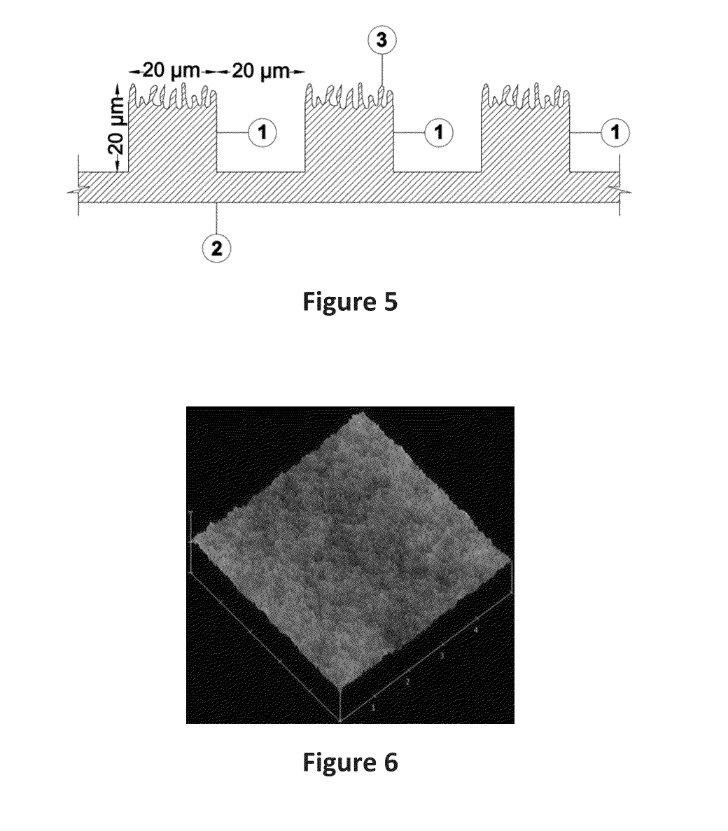

Referring to FIG. 4, the present invention entails a two-step process for producing a stable hydrophilic surface of fibrillar structures, and altering the surface morphology of polymer fibrils, to be used as removable adhesive. In the first step (Referring to FIG. 4B), the fibril tips are treated using UV/Ozone (UVO) or oxygen plasma, which introduce, on polymer surfaces, such oxygen-related functional groups as proxy, hydroxyl, carbonyl, carboxylic acid, etc. These functional groups enhance the wettability of polymer surfaces, providing for potentially dramatic lowering of the water contact angle of surfaces referring to FIG. 3). For example, the water contact of polyurethane fibrillar structures (Referring to FIG. 1) dropped to 15 degree after either UVO or oxygen plasma treatment. Under proper operation conditions, using at least one of UVO and oxygen plasma treatment methods provides fibrils (FIG. 5, component 1) with nanostructured tip surfaces (FIG. 5, component 3), producing hierarchical structures simulating those of gecko-foot. These hierarchical structures comprise micro-fibrils culminating in nanostructured tips. Hierarchical structures can conform to surface roughness at different scales, rendering effective contact and desired adhesion qualities. Formation of the nanostructured morphology on fibril tips (FIG. 5, component 3) is a result of non-uniform material etching during surface treatment. The fibrils (FIG. 5, component 1) are anchored on a backing layer (FlG. 5, component 2), which acts as a foundation supporting the fibrils; the flexibility of this backing layer improves the ability of the fibrillar structure to conform to surface roughness at different scales.

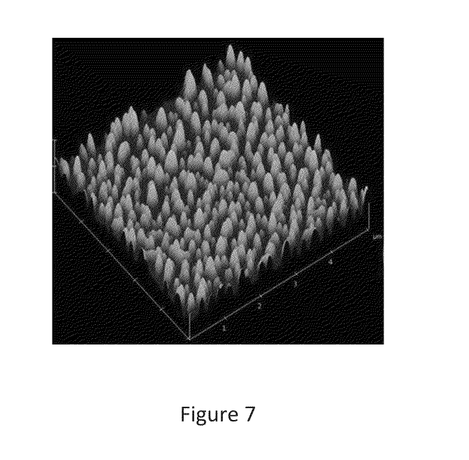

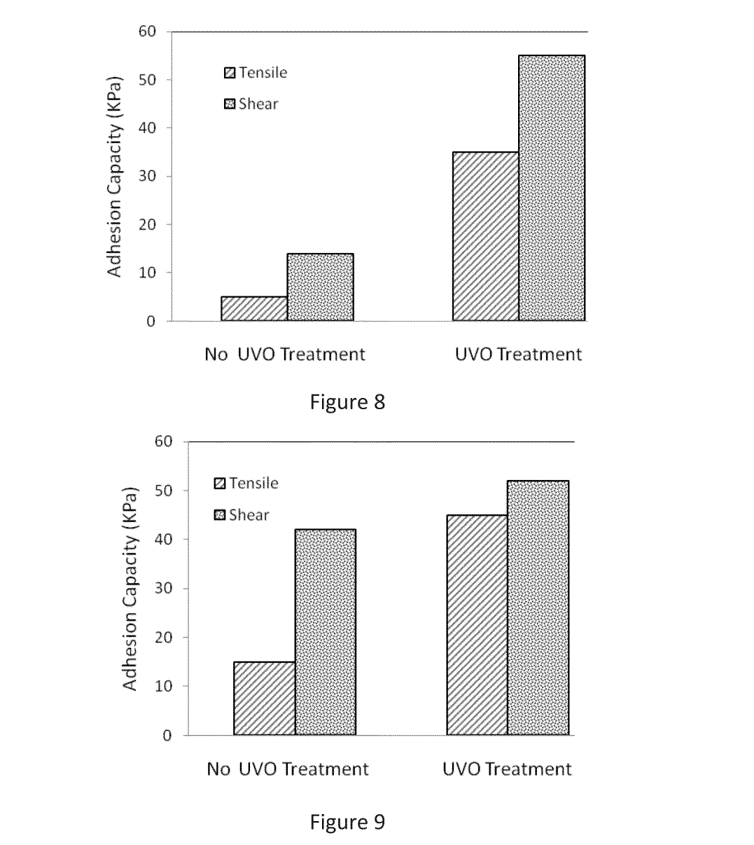

UVO is a photosensitized oxidation process which relies upon absorption of short-wavelength UV radiation to excite and/or dissociate fibril tip molecules. UVO treatment also renders an etching effect, which increases the fibril tip surface roughness. FIGS. 6 and 7 show an example surface prior to and after UVO treatment. A comparison of these figures indicates that UVO treatment significantly increases the surface roughness. This rise in roughness together with molecular dissociations at fibril tips benefit the adhesion capacity of fibrillar structures, as shown in FIGS. 8 and 9 for polyurethane and PDMS fibrillar arrays, respectively.

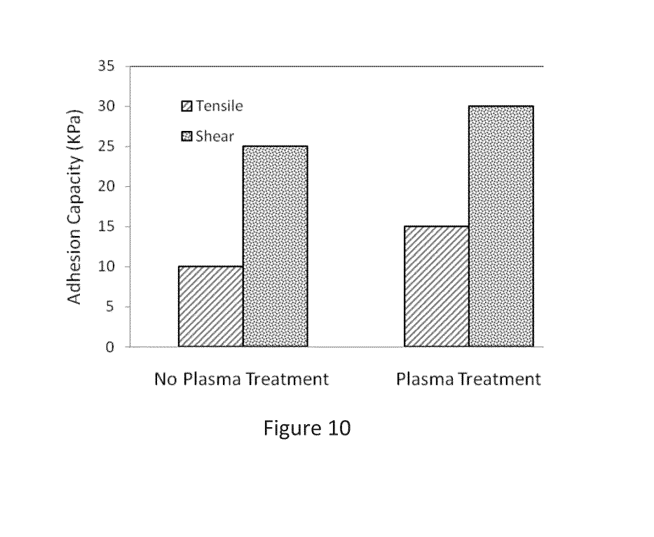

Another preferred method for improving water wettability of fibrillar surfaces is the use of low-pressure oxygen plasma treatment. This method offers advantages in terms of stability and convenience. Oxygen plasma treatment causes a loss of the hydrophobicity of polyurethane, PDMS and other surfaces. Said treatment causes breakage of chemical bonds through bombardment of the polymer surface with high-energy ions, producing dangling bonds which react with the hydroxyl groups from atmosphere when exposed to air. This explains the significant decrease of water contact angle after plasma treatment. Like UVO treatment, oxygen plasma treatment also roughens the fibril tip. Oxygen plasma treatment benefits the adhesion capacity of polymeric fibrillar structures (FIG. 10) by increasing their wettability and also by roughening the fibril tip which produces hierarchical morphologies comprising coarser fibrils with finer features (roughness) introduced on fibril tips.

Referring to FIG. 4C, the second step in surface treatment is coating with a thin layer of polyelectrolyte after UVO or oxygen plasma treatment. This step hinders hydrophobic recovery of fibril tip surfaces. Coating with a polyelectrolyte via self-assembly improves the stability of UVO or oxygen plasma treated surfaces over time. Polyelectrolytes are polymers whose repeating units bear electrolyte groups which dissociate in aqueous solutions, making the polymers charged. Polyelectrolytes can be linear, branched, or crosslinked, or copolymers. Examples include polyethyleneimine (PEI), poly(allyl amine) (PAH), polyacrylic acid, polystyrene sulfonate, and poly(diallyl dimethyl ammonium chloride) (PDAC).

Preferred polyelectrolytes are positively charged (or cationic) polyelectrolytes such as PAH, PEI and PDAC, especially PEI. UVO or oxygen plasma treatment of fibril tips (FIG. 4B) renders negatively charged fibril tip surfaces. A thin (nano-scale) layer of positively charged polyelectrolyte can thus be assembled by electrostatic attraction (FIG. 4C) or optionally hydrogen bonding. Self-assembly of polyelectrolytes provides the ability to penetrate the (nano- and micro-scale) surface roughness (Referring to FIG. 4D). This thorough treatment of fibril tip surfaces enables effective use of capillary force in addition to van der Waals attraction towards improvement of the adhesion capacity of firballar arrays.

The invented methods are further illustrated by the following examples, but the particular materials and their amounts introduced in the examples as well as other details should not be considered as limitations for the invented methods.

### EXAMPLE

Step 1: Fabrication Process of Polymer Microfibrillar Structure

Polymer microfibrillar structures were produced by soft-molding of elastomeric precursors on micro fabricated template. This approach can be used for fabrication of fibrils of any dimensions. The template was produced by the photolithographic process, which is a prevailing method of batch-transferring micro-scale patterns. In the photolithography process, an ultraviolet light shines through a two-dimensional photomask onto a light-sensitive chemical photoresist applied upon a substrate. This process removes the photoresist at undesired areas, leaving a three-dimensional (fibrillar) structure on the substrate, with a height that is equal to the thickness of the photoresist. This remaining photoresist structure is then used in a micro-molding process. For the purpose of fabricating the lithographic SU-8 templates, a glass wafer was used to prevent UV reflections during lithography. A thin layer of diluted SU-8 photoresist polymer was spun onto the glass wafer to produce a thin polymer backing for the fibrillar array, and to improve the adherence of SU-8 fibrils to the substrate. This thin backing layer was baked and uniformly exposed to UV radiation. Subsequently, another layer of SU-8 was spun on top of the thin layer, and the fibrillar pattern was developed by photolithography.

Step 2: Soft-Molding on the Lithographic Templates

For the purpose of soft-molding on lithographic templates, silanization of the SU-8 patterned wafers is necessary to avoid adherence to the mold, and facilitate demolding. This was accomplished using heptadecafluoro-1,1,2,2-tetrahydrooctyltrichlorosilane (hepta-fluorosilane). Silanization over the gas phase was conducted in an evacuated desiccator for 1 hr, followed by baking at 95° C. for 1 hour. Polyurethane (PU) (ST-3040, BJB Enterprises, Inc) was used for fabricating microfibrillar structures. After mixing components A and B of the ST-3040 polyurethane, the mixer was degassed, and poured on the template under light vacuum so that the liquid can fill into the patterned structure. The polymer was cured at 65° C. for 24 hr, and then demolded carefully to avoid template damage. The total thickness of the elastomer samples was approximately 1 mm with fibrils having 20 μm diameter and 20 μm length.

Step 3: Enlargement of Microfibril Tips

This step involves enlargement of the fibril tips in microfibrillar array, with the objective of producing a mushroom-shape tip for enhanced adhesion. This is accomplished by “inking” the fibril tips in a spinned film of a polymer precursor followed by “printing” against a smooth surface. Polyurethane (ST-3040 PU) fibrillar arrays with 20 μm fibril diameter and length were used for treatment of fibril tips. Components A and B of the polyurethane (ST-3040 PU) were mixed, degassed and spin-coated onto a silicon wafer. The thickness of the coating was measured with a Veeco Dektak 3 surface profiler. The spin speed was optimized at 1200 rpm for 18 s, and 7700 rpm for 1 min to produce a targeted film thickness of ˜6 μm. The PU fibrillar arrays were inked in the film immediately after coating. A two-axis micropositioning stage (UMR3.5, Newport, Irvin, Calif.) was used to move the array towards the film and then detach it immediately after contact to prevent suck-in. The sample and wafer were aligned visually using a microscope. The inked PU arrays were pressed against a perfluorosilanized wafer before curing for obtaining spatula-like structures. Silicon wafers were first cut into 2.5 cm squares, which were cleaned in piranha solution (70% H₂SO₄: 30% H₂O₂) overnight, rinsed with deionized water, and dried with nitrogen. The wafer was then treated using gas-phase silanization performed with heptadecafluoro-1,1,2,2-tetrahydrooctyltrichlorosilane in an evacuated desiccator for 1 hr, and baked for 30 min at 95° C. A microscope image of the fibrils with enlarged (mushroom-shaped) tips is shown in FIG. 1.

Step 4: UV/Ozone or Oxygen Plasma Treatment of the Microfibrillar Structure

A desktop-type Photo Surface Processor (Model: PL16-110) was used for UV/Ozone treatment of polyurethane fibrillar arrays. The degree of ozone treatment can be controlled by the time of exposure and the distance between the processor and the fibrillar array. Fibrillar structures were treated for 30 minutes. The water contact angle of PU fibrillar array before UV/Ozone treatment was measured at about 120° (FIG. 2), which was reduced to 15° (FIG. 3) after UV/Ozone treatment. Changes in fibril tip morphology caused by UV/Ozone treatment (FIG. 5 and FlG. 6) and wettability (reduction in water contact angle) produced gains in the shear and tensile adhesion capacities of PU fibrillar arrays (FIG. 8) measured in 50% relative humidity against a glass surface (FIG. 8).

The fibrillar array with modified fibril tips was prepared as described in Steps 1 and 2. Oxygen plasma treatment was performed on the fibrillar array using a PlasmaQuest 4532 RIE. The following conditions were used for oxygen plasma treatment: Ar 10 ccm/O₂ 15 ccm/Microwave 700 W/RF 200 W//10 mTorr/600 s. Ten minutes of low-pressure oxygen plasma treatment improved the adhesion capacity of the fibrillar array (FIG. 9). The wettability of fibrillar structure was assessed by measuring its water contact angle, which was reduced from 120° (FlG. 2) prior to treatment to 15° (FIG. 3) after oxygen plasma treatment.

Step 5: Coating with Polyelectrolytes

Oxygen plasma treatment was used to treat the tip modified fibrillar arrays as described in in Step 4. In order to preserve the hydrophilic properties of fibrillar array over time after oxygen plasma treatment, fibrillar tips were coated with a thin layer of polyethyleneimine. For this purpose, a solution of 3 wt. % polyethyleneimine in DI water was prepared. The fibrillar array was placed in this solution for one hour. The array was then removed from the solution and rinsed with DI water for three times; it was subsequently dried under nitrogen gas. This procedure coats the fibril tip surfaces with a thin PEI layer, which helps preserve the hydrophilic properties of the oxygen plasma-treated the fibrillar array over time.

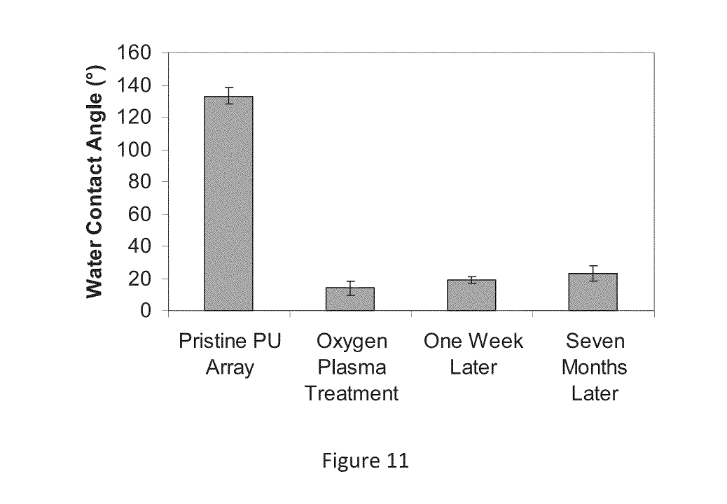

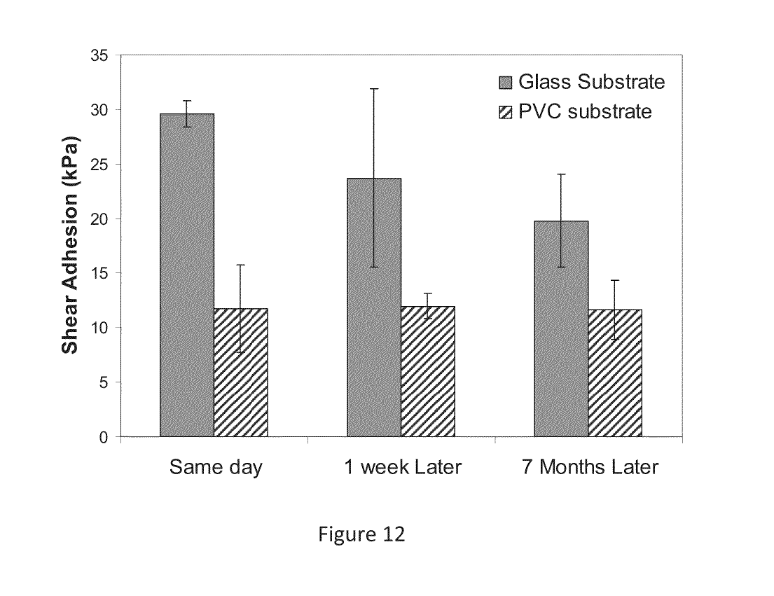

The stability of hydrophilic surfaces of fibrillated adhesive was examined by measuring the water contact angle over storage time in air. After various storage times, the water contact angle was measured for fibrillar arrays subjected to O₂ plasma treatment followed by PEI coating. FIG. 11 shows the water contact angles of PU fibrillar array before and after O₂ plasma treatment followed by PEI coating. The water contact angle barely changed during seven months of storage in air. The shear adhesion properties were also measured against glass and polyvinyl chlorite (PVC) sheet, as shown in FIG. 12. The shear adhesion slightly decreased against glass with time, but it barely changed against PVC.

While the invented methods are described in terms of preferred embodiment, they should not be construed as limiting the scope of the invented methods. Variations and modifications of the present invented methods can be deducted by those skilled in the art, and they are intended to be covered in the following appended claims.

What is claimed is:

1. A method of making hierarchical polymer structures for use as dry adhesives, with said structures comprising an array of polymer fibrils with 1 to 500 micrometer diameter and 1 to 10,000 micrometer length, with nanostructured fibril tip surfaces which are stable over time and provide hydrophilic behavior, with said hierarchical polymer structures enabling accommodation of the surface roughness at different scales for establishing effective contact and strong adhesion via van der Waals interactions and capillary forces, and said method comprising the steps of:
fabrication of the array of polymer fibrils using at least one of methods involving introduction of incisions on polymer films, hot embossing of polymer melts with micro-fabricated masters, direct drawing of polymer fibrils, lithographic structuring of resist films, filling of porous membrance, and soft-molding of elastomeric precursors on micro-fabricated templates;
surface treatment of the fibril tips using at least one of UV/Ozone and plasma treatments, to produce nanostructured surfaces with oxygen-related functional groups such as proxy, hydroxyl, carbonyl, and carboxylic acid which provide hydrophilic qualities;
coating the nanostructured fibril tip surfaces with a thin layer of polyelectrolytes to ensures long-term stability of the nanostructured, hydrophilic surfaces of said fibril tips.

2. The method of claim 1, wherein the array of polymer fibrils is made of at least one of epoxy, poly(methyl methacrylate) (PMMA)), polypropylene (PP), polyurethane (PU) and polydimethylsiloxane (PDMS) polymers.

3. The method of claim 1, wherein said polyelectrolytes are charged polymers selected from a group of cationic polyelectrolytes, including polyethyleneimine (PEI), poly(allyl amine) (PAH), and poly(diallyl dimethyl ammonium chloride) (PDAC).

4. An article of hierarchical polymer structures comprising an array of polymer fibrils with 1 to 500 micrometer diameter and 1 to 10,000 micrometer length, with nanostructured fibril tip surfaces which are coated with polyelectrolytes, providing hydrophilic behavior and long-term stability, with said hierarchical polymer structures enabling accommodation of the surface roughness at different scales for establishing effective contact and strong adhesion via van der Waals interactions and capillary forces.

5. The article of claim 4, wherein the array of polymer fibrils is made of at least one of epoxy, poly(methyl methacrylate) (PMMA)), polypropylene (PP), polyurethane (PU) and polydimethylsiloxane (PDMS) polymers.

6. The article of claim 4, wherein said polyelectrolytes are charged polymers selected from a group of cationic polyelectrolytes, including polyethyleneimine (PEI), poly(allyl amine) (PAH), and poly(diallyl dimethyl ammonium chloride) (PDAC).

7. The article of claim 4, wherein surfaces of said hierarchical polymer structures provide a water contact angle less than or equal to 30°.
